(19) United States
(12) Patent Application Publication
(10) Pub. No.: US 2010/0293492 A1
(43) Pub. Date: Nov. 18, 2010

(54) Systems, Web Sites, Games, Calculators, Meters and Other Tangible Items for Measurement of Love

(76) Inventor: Lewis Farsedakis, Boca Raton, FL (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/778,405

(22) Filed: May 12, 2010

Related U.S. Application Data
(60) Provisional application No. 61/177,469, filed on May 12, 2009.

(51) Int. Cl. G06F 3/048

(52) U.S. Cl. 715/771; 715/843; 715/764

(57) ABSTRACT

A computer-implemented system including a web site or an input device receives input from a user to rate a relationship, such as a romantic relationship, based on a set of parameters each of which parameter the user rates numerically, with the numerical ratings for a relationship being susceptible of update by the user over time. The system has the capacity to store and manage a plurality of various relationships of the user. For each relationship, the system separately stores and manages data and receives updated input from the user.

### RELATED APPLICATION

Benefit is claimed to U.S. provisional application ser. No. 61/177,469 filed May 12, 2009, by Lewis Farsedakis, titled “Games, Calculators, Meters and Other Tangible Items for Measurement of Love Between a User and Loved One.”

### FIELD OF THE INVENTION

The invention relates generally to computer-based systems in which a subjective emotion is represented as a set of numerically-evaluated parameters for which a human user's input is collected by a computer-based system, and more particularly to computer-based data processing and visual display of such collected and processed information for the user's personal use.

### BACKGROUND OF THE INVENTION

An individual likely has a number of different ongoing, concurrent relationships of a variety of descriptions, such as boyfriend, girlfriend, spouse, colleague, sibling, parent, child, friend, teammate, mentor, mentee, aunt, uncle, niece, nephew, godparent, daughter-in-law, son-in-law, student, teacher, tutor, coach, therapist, employee, employer, etc. He may want to privately consider and evaluate some of these relationships from time to time. For example, sometimes an individual might keep a private, handwritten, free-form diary or journal making entries from time to time in which he memorializes his thoughts about one or more particular persons with whom he has a relationship. But with existing methods, to privately measure, organize and refer back to one's thoughts over a period of time can be difficult even just for one relationship, much less for the plurality of relationships to which the individual belongs in everyday modern life.

### SUMMARY OF THE INVENTION

In one preferred embodiment, the invention provides a product which is a game, calculator, meter, scale or other tangible item, comprising: an input device through which is received on a plurality of occasions, input that is entered by a human user and that relates to at least one emotion that is a measure of love; a computation system that processes a current input entered by the human user including integrating the current input entered by the human user with a set of previous inputs entered by the human user to compute a result representing love between the user and a loved one; and a display on which is output the result; such as, e.g., an inventive product in which the input device is configured to receive input for a collection of measured emotions selected from the group consisting of shared emotional space; affection; appreciation; admiration; empowerment of oneself; empowerment of the loved one; respect; loyalty; trust and shared history, or a combination thereof; an inventive product which is reusable over time, to obtain a measurement or computation of love between the user and the loved one at different points in time; and other inventive products.

The invention in another preferred embodiment provides a product which is a game, calculator, meter, scale or other tangible item, in which love between a user and a loved one is computed or measured as a collection of measured emotions of the user selected from the group consisting of: shared emotional space; affection; appreciation; admiration; empowerment of oneself; empowerment of the loved one; respect; loyalty; trust and shared history, or a combination thereof, such as, e.g., a computerized device; a mechanically-based device or game; a game in which the measured emotions are represented by a ball, a pebble, or another object placeable by a user; an inventive product which is reusable over time, to obtain a measurement or computation of love between the user and the loved one at different points in time; and other inventive products.

The invention in another preferred embodiment provides a website configured for a user who is one individual to measure the collection of emotions that make up love from that one individual's perspective (i.e. relative to himself or herself).

In another preferred embodiment the invention provides a computer-implemented system comprising: a website or an input device through which is received on a plurality of occasions input that is entered by a human user and that relates to at least one emotion that is a measure of love; a computation system that processes a current input entered by the human user including integrating the current input entered by the human user with a set of previous inputs entered by the human user to compute a result representing love between the user and a loved one; and an outputting system that outputs the result to be displayed to the user; such as, e.g., an inventive system in which the website receives input for a collection of measured emotions selected from the group consisting of shared emotional space; affection; appreciation; admiration; empowerment of oneself; empowerment of the loved one; respect; loyalty; trust and shared history, or a combination thereof; an inventive system in which the website is a website configured for a user who is one individual to measure the collection of emotions that make up love from that one individual's perspective (i.e. relative to himself or herself); and other inventive systems.

The invention in another preferred embodiment provides a computer-implemented system comprising: a website or an input device through which is received on a plurality of occasions input that is entered by a human user and that relates to at least one selected from the group consisting of (a) an emotion that is a measure of love for which the user may input an evaluation by the user using a numerical scale and (b) a parameter for which the user may input an evaluation by the user using a numerical scale; a computation system that processes a current input entered by the human user including integrating the current input entered by the human user with a set of previous inputs entered by the human user to compute a result; and an outputting system that outputs the result to be displayed to the user; such as, e.g., an inventive system that displays each emotion or each parameter separately to the user with each displayed emotion or parameter having displayed therewith a numerical rating tool for the user to operate to provide the user's current numerical rating input for the respective emotion or parameter; and other inventive systems.

### BRIEF DESCRIPTION OF THE DRAWINGS

The invention may be appreciated with reference to the figures submitted herewith, without the invention being limited thereto.

FIG. 1 is an example of a screen from a system according to the invention, for receiving a set of Relationship Names, one by one, as inputted by a user.

FIG. 2 is a screen that corresponds to FIG. 1 after the system has received two Relationship Names inputted by the user.

FIG. 3 is a Rate an example of a Rate a Relationship screen to receive a user's rating of a relationship shown on FIG. 2 via the user's number-based rating of seven ratable categories including Affection, Respect, Admiration, Empowerment, Loyalty, Intimacy and Appreciation.

FIG. 4 is an example of a numerical rating tool 400 useable in the invention for the user to operate to input the user's numerical rating for a parameter that the system displays to user.

### DETAILED DESCRIPTION OF PREFERRED EMBODIMENT

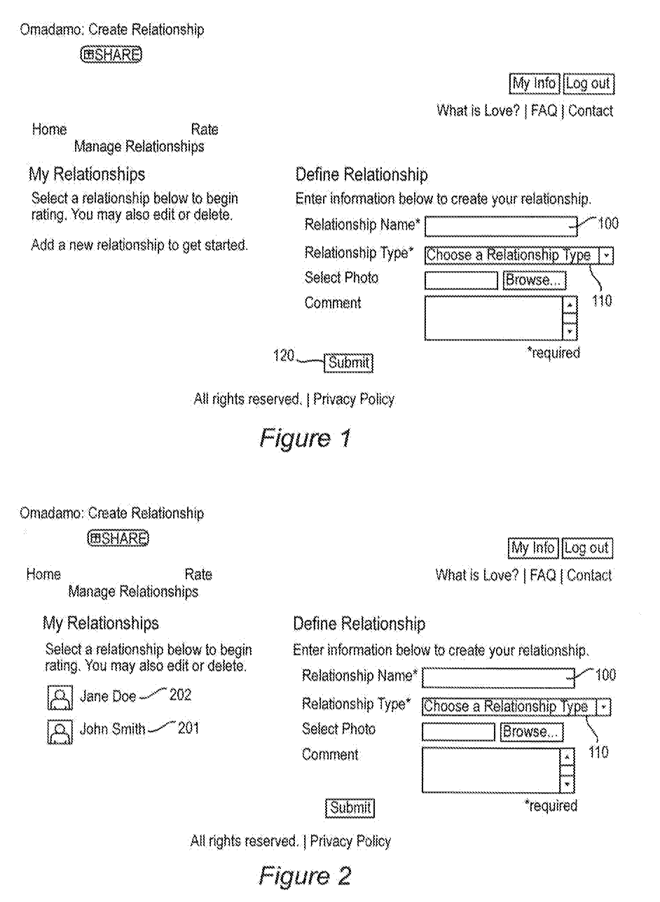

Referring to FIGS. 1-4, a preferred embodiment of the invention may be appreciated without the invention being limited thereto. Inventive products and systems may be used, for example, by a user who is one individual to numerically measure or evaluate the collection of emotions that make up love from that one individual's perspective (i.e. relative to himself or herself), using the same underlying numerically-based analysis over time.

Herein, a “user” refers to a human user, namely, a human user to whom a computer-based system presents input fields into which the user selects a response within a range of response options provided by the system. For such data collected by the system from the user, the system associates a date therewith and stores the data, and makes the stored data along with its associated date available to the user for retrieval and review by the user (such as in a form of a read-only record) on an ongoing basis.

An example of an inventive system is a computer-implemented system comprising a website or an input device through which is received on a plurality of occasions input that is entered by a human user (such as, e.g., input that is entered by a human user and that relates to an emotion that is a measure of love for which the user may input an evaluation by the user using a numerical scale; input that is entered by a human user and that relates to a parameter for which the user may input an evaluation by the user using a numerical scale; etc.). Preferably the system comprising the website or the input device also comprises a computation system that processes a current input entered by the human user including integrating the current input entered by the human user with a set of previous inputs entered by the human user to compute a result. Preferably the system comprising the website or the input device also comprises an outputting system that outputs the result to be displayed to the user.

For example, inventive computer-implemented products and systems display fields to a human user to receive the user's input, receive input (including numerical ratings) from the user, process numerical ratings that the user input into the system, display a computed current total rating to the user, and continue over time (such as over days, weeks, months, etc.) to receive numerical ratings from the user. An example of an inventive system is a computer-implemented system comprising: a website or an input device through which is received on a plurality of occasions input that is entered by a human user and that relates to at least one emotion that is a measure of love for which the user may input an evaluation by the user using a numerical scale (or, alternatively, a parameter for which the user may input an evaluation by the user using a numerical scale); a computation system that processes a current input entered by the human user including integrating the current input entered by the human user with a set of previous inputs entered by the human user to compute a result; and an outputting system that outputs the result to be displayed to the user.

A preferred example of an inventive system's displaying of fields to a user includes, e.g., the website or the input device displaying a Relationship Name input field (such as Relationship Name input field 100) into which is received, one by one for each respective relationship of a set of relationships R₁ . . . Rₙ where n is an integer greater than or equal to 1, a Relationship Name that is a string of characters created by the user.

Preferably, the system provides a secure log-in for a user to reach a screen such as FIG. 1, and otherwise maintains input by a user as private to the user who provided the input.

As shown in FIG. 1, the website (or alternately the'input device) displays a Relationship Name input field 100 into which the user can freely type a Relationship Name that is a string of characters created by the user. For example, the user can freely type into input field 100 the name of a person that the user wishes to rate, such as typing “John Smith”.

Referring to FIG. 1, the website displays the Relationship Name input field 100 along with a Relationship Type input field 110 having a drop-dawn menu, so that for each Relationship Name that is entered by the user via the input field 100 and received by the system, the system also receives as input a selection made by the user from the drop-down menu for input field 110 that is the user's characterization of the relationship. In FIG. 1, Relationship Name and Relationship Type are shown as “required” fields for which the user provides input before hitting the “submit” button. Alternately, the system may be constructed with “Relationship Type” as an optional field, or without a “Relationship Type” field and instead only using “Relationship Name” as input by the user. When a system is constructed to receive “Relationship Type” from the user, examples include, e.g, boyfriend, girlfriend, husband, wife, colleague, etc. Preferably an inventive system includes a website or input device that displays a Relationship Name input field (such as field 100) along with a Relationship Type input field (such as field 110) having a drop-down menu, so that for each Relationship Name that is entered by the user and received by the system, the system also receives as input a selection made by the user from the drop-down menu that is the user's characterization of the relationship.

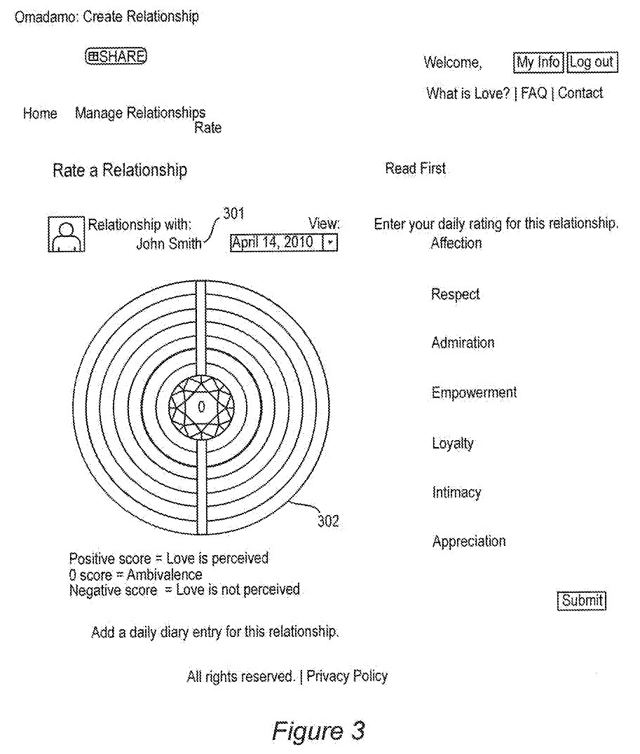

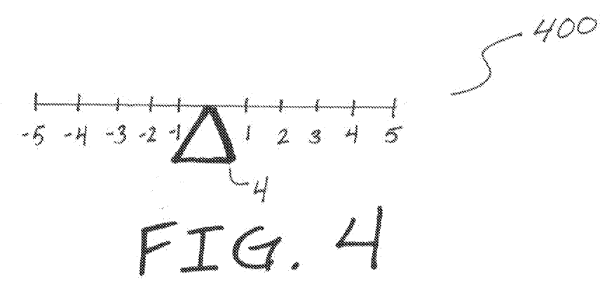

FIG. 2 shows a screen after a user has inputted “John Smith” as a Relationship Name into the input field 100, hit “submit” 120, inputted “Jane Doe” as a Relationship Name into the input field 100, and hit “submit” 120. The system is capable of receiving another new Relationship Name via input field 100 as entered by the user, or of having the user click on a relationship (such as the “Jane Doe” relationship 202 or the “John Smith” relationship 201) to access provide ratings tools to be used by the user. Preferably, when the user clicks on a relationship (such as the “John Smith” relationship 201 in FIG. 2), the system displays to the user options including “View”. “Edit” and “Delete” (not shown in FIG. 2). If the user clicks on the “Delete” option, the user can delete the relationship. If the user clicks on the “Edit” option, the user can edit aspects such as “Relationship Name” or “Relationship Type”. If the user clicks on the “View” option for the “John Smith” relationship 201 in FIG. 2, the system displays the screen shown in FIG. 3 to the user, which is a Rate a Relationship screen for the Relationship with John Smith 301.

The Rate a Relationship screen shown in FIG. 3 displays to the user a set of seven emotions (see Example 1 herein) which is an illustration of a preferred set of emotions or parameters to display to a user. In other embodiments, a system or product may be constructed with more, fewer, and/or different sets of emotions (or parameters) that are displayed to the user. Preferably, once a system or product displays a set of emotions or parameters to a user, the set of emotions or parameters will remain constant over time.

Optionally, a system or product may be constructed in which the system displays a suggested menu of ingredients to the user (such as the seven ingredients shown in FIG. 3), and the system gives the user the option to delete one or more of the ingredients and/or to add one or more user-named ingredients.

Preferably a screen according to FIG. 3 also displays, for each ingredient (such as Affection, etc.) a numerical rating tool (not shown in FIG. 3). The system is configured to receive the user's input separately for each ingredient. In a preferred example, the system displays each emotion or parameter separately to the user with each displayed emotion or parameter having displayed therewith a respective unique numerical rating tool for the user to operate to provide the user's current numerical rating input for the respective emotion or parameter.

A preferred example of a numerical rating tool is shown in FIG. 4, depicting slidable rating tool 400 which can be used on the Rate a Relationship screen (FIG. 3) seven respective times, once next to each ingredient. The system is configured so that a user can use his mouse to drag pointer 4 along a number-line. In FIG. 4, the system places pointer 4 initially at zero, and permits the user to drag pointer 4 to positions in a positive direction, namely, 1, 2, 3, 4 or 5, or in a negative direction, namely −1, −2, −3, −4 or −5. The use of 5 positions in either direction is only illustrative and slidable rating tools may use a variety of number lines. Preferably a numerical rating tool used in the invention includes a display comprising at least {−1, 0, 1}, with a preferred example of a numerical rating tool including a display of (−5, −4, −3, −2, −1, 0, 1, 2, 3, 4, 5).

A website or an input device having features as shown in FIGS. 1-4 may be used, for example, to receive on a plurality of occasions input that is entered by a human user and that relates to at least one emotion that is a measure of love; and wherein the computed result is a result representing love between the user and a loved one.

Preferably an inventive system that includes a website is useable by a plurality of users, and includes a secure log-in, wherein input that the system collects from a respective user is maintained as private with access only being given to the respective user.

In addition to displaying the numerical rating tool, inventive systems optionally may also further display a color-coded visual display, such as a color-coded visual display in which selection by the user of zero causes a certain color to display, selection of the user of a negative number causes a color other than the certain color displayed for zero to display, and selection of the user of a positive number causes a color other than the certain color displayed for zero or the certain color displayed for a negative number to display. In a preferred example, a system is constructed in which a certain first color is associated with zero, a certain first range of colors different than the first color is associated with positive numbers, and a certain second range of colors different than the first color and different than the first range of colors is associated with negative numbers. A preferred example is use of a numerical rating tool that includes at least four non-zero numbers (such as tool 400), and wherein each number in the numerical rating tool has a distinct color associated therewith that the system displays to the user upon selection by the user of the number.

A preferred example of a format used by an inventive system to display a color associated with a number selected by a user using a numerical rating tool is a circular display that is segmented into respective regions such as circular display 302. Circular display 302 is divided into a center in which the computed total numerical rating displays as a number. In FIG. 3, the number zero is shown in the center of circular display 302 only by way of illustration. In circular display 302, respective concentric bands are used with one concentric band for each parameter (such as Affection) that the system presents to the user for the user to input a numerical evaluation. When the user selects a numerical response for a given parameter using the numerical ratings tool, the system automatically adjusts the color of that parameter's corresponding concentric band in the circular display 302. In a preferred example, when the user selects a positive number for a given parameter, the system displays a corresponding color to that number only on the right-hand side of the display 302 and when the user selects a negative number for that given parameter, the system displays a corresponding color to that number only on the left-hand side of the display 302. Each parameter displayed to the user for the user to rate has its own respective concentric color band in display 302.

It should be appreciated that circular display 302 is illustrative and that color displays used in the invention may be a variety of shapes and sizes.

The following examples are illustrative and the invention is not limited thereto.

### Example 1

### Measuring Love, 7 Ingredients

In this example, what is being measured is Love, and 7 ingredients or parameters are defined, with each ingredient being susceptible of number-based rating by the user: Affection; Respect; Admiration; Empowerment; Loyalty; Intimacy; and Appreciation.

### Example 1A

### Measuring Love, System's Instructions Displayed to the User

In this example, the following instructions are displayed by the system to the user.

Step 1: Assign each of the 7 ingredients one of the following scores; −5, −4, −3, −2, −1, 0, 1, 2, 3, 4, 5. Use a negative score to indicate a degree of non-pleasure, use 0 to indicate ambivalence and use a positive score to indicate a degree of pleasure.
Be honest with yourself. You should only give a score of +5 if you cannot think of anything else that your loved one can do to satisfy you more for a particular ingredient. It may be helpful to list what a +5 score should include according to you, and remove a point for each major item that is not present to your satisfaction in your relationship. The list can be used to provide a detailed explanation to your loved one about your scoring methodology. Nothing is set in stone; you can always edit your list as you go along because it is what you perceive as important that matters. YOU determine the score you feel your loved one deserves for each ingredient (not what your loved one thinks they should score).
The calculating tool will instantly provide you with your total score. The minimum total score possible is −35 and the maximum is +35. The result is the initial Love Quotient: DO NOT show each other your scores just yet.
A positive score indicates that you perceive love at the moment
A zero score indicates that you are ambivalent to the relationship at the moment
A negative score indicates that you do not perceive love at the moment

### Example 2

In this example, the instructions to the user begin with those of the preceding example and also include the following:

Step 2: Using the calculating tool again—but this time without clicking SUBMIT—score each ingredient how YOU THINK your loved one should have scored you. Write down the total Love Quotient.
Step 3: COMPARE Love Quotient scores with your loved one. The closer the score you gave yourself in step 2 is to the score your loved one gave you in step 1, the more your love relationship is based on reality. The further apart the scores are, the more your relationship is based on fantasy.

### Example 2A

In this example, the instructions to the user begin with those of Examples 1 and 2 and also include the following:

Step 4: Discuss the variances and clearly communicate to each other what a +5 would entail for each ingredient BEFORE you begin the INTOX period as described in STEP 5. If your loved one brought up any issues that you may have forgotten and agree with, feel free to incorporate them into your scoring in the future (only if YOU feel you should).
Step 5 (INTOX): Each day, for the next 28 days, you and your loved one will both work on the same ingredient and score it daily, starting with Affection. Score your loved one on how you feel on that day, even if the score remains the same. Over a 28 day period, you will score each of the 7 ingredients at least 4 times, focusing on one ingredient per day. Consider the quantity, quality and intensity of the experience when you are scoring an ingredient. If you don't feel an effort was made that day for an ingredient, score it 1 point less than what you scored it on the initial Love Quotient. Communicate your scoring and its reasoning daily to your loved one to open up the communication channel. This will allow your loved one to hone in to your specific needs and do better as time goes by, building a stronger love relationship along the way.
At the end of the 28 days, you will have scored each ingredient 4 times. Adding up all 4 scores for each ingredient:
1. Click on HISTORY to see your average Love Quotient after your INTOX. Has the score increased or decreased?
2. Compare your INITIAL Love Quotient (by clicking on the first day you started scoring) and the INTOX Love Quotient. This will determine if there has been any change.
3. Schedule some alone time to discuss why the results have increased, stayed the same or decreased. The most important question at all times is: are you both committed to working at building a better love relationship?
   Step 6 (MAINTAIN): Ideally you should work on an ingredient each day, focusing on weaker ones first until they even up with the others. The more frequently and creatively you work at each ingredient, the greater the accumulation of pleasurable experiences. With pleasurable experiences accumulating faster than non-pleasurable experiences, your love relationship will continue to grow stronger, provided both you and your loved one remain committed to continuously work at it.

It will be appreciated that variations and modifications from the embodiments set forth above may be made without departing from the spirit of the invention, and that such modifications are to be considered within the present invention.

What is claimed by the inventor, Lewis Farsedakis, as my invention is:

1. A computer-implemented system comprising:
a website or an input device through which is received on a plurality of occasions input that is entered by a human user and that relates to at least one selected from the group consisting of (a) an emotion that is a measure of love for which the user may input an evaluation by the user using a numerical scale and (b) a parameter for which the user may input an evaluation by the user using a numerical scale;
a computation system that processes a current input entered by the human user including integrating the current input entered by the human user with a set of previous inputs entered by the human user to compute a result; and
an outputting system that outputs the result to be displayed to the user.

2. The computer-implemented system of claim 1, wherein the website or the input device is a website or an input device through which is received on a plurality of occasions input that is entered by a human user and that relates to at least one emotion that is a measure of love; and wherein the computed result is a result representing love between the user and a loved one.

3. The system of claim 1, wherein the website or the input device displays a Relationship Name input field into which is received, one by one for each respective relationship of a set of relationships R₁ . . . Rₙ where n is an integer greater than or equal to 1, a Relationship Name that is a string of characters created by the user.

4. The system of claim 3, wherein the website or the input device displays the Relationship Name input field along with a Relationship Type input field having a drop-down menu, so that for each Relationship Name that is entered by the user and received by the system, the system also receives as input a selection made by the user from the drop-down menu that is the user's characterization of the relationship.

5. The system of claim 1, wherein the system displays each emotion or each parameter separately to the user with each displayed emotion or parameter having displayed therewith a numerical rating tool for the user to operate to provide the user's current numerical rating input for the respective emotion or parameter.

6. The system of claim 1, being useable by a plurality of users, and including a secure log-in, wherein input that the system collects from a respective user is maintained as private with access only being given to the respective user.

7. The system of claim 5, wherein the numerical rating tool includes a display comprising at least {−1, 0, 1}.

8. The system of claim 7, wherein the numerical rating tool includes a display of {−5, −4, −3, −2, −1, 0, 1, 2, 3, 4, 5}.

9. The system of claim 7, wherein the system in addition to displaying the numerical rating tool further displays a color-coded visual display in which selection of the user of zero causes a certain color to display, selection of the user of a negative number causes a color other than the certain color displayed for zero to display, and selection of the user of a positive number causes a color other than the certain color displayed for zero or the certain color displayed for a negative number to display.

10. The system of claim 9, wherein the numerical rating tool includes at least four non-zero numbers, and wherein each number in the numerical rating tool has a distinct color associated therewith that is displayed to the user upon selection by the user of the number.
